(19) United States
(12) Patent Application Publication
(10) Pub. No.: US 2022/0141549 A1
(43) Pub. Date: May 5, 2022

(54) TEMPORAL BEHAVIOR-DRIVEN CURATION OF SHORT-FORM MEDIA SEGMENTS

(71) Applicant: AT&T Intellectual Property I, L.P., Atlanta, GA (US)

(72) Inventors: Subhabrata Majumdar, Jersey City, NJ (US); Deirdre Paul, Morristown, NJ (US); Eric Zavesky, Austin, TX (US)

(21) Appl. No.: 17/089,640

(22) Filed: Nov. 4, 2020

(51) Int. Cl. H04N 21/845; H04N 21/234

(52) U.S. Cl. CPC H04N 21/8456; H04N 21/23418; H04N 21/23424

(57) ABSTRACT

An example method includes extracting a plurality of candidate content segments from a first item of media content, wherein the plurality of candidate content segments is extracted over a first window of time and a second window of time, determining, for a first candidate content segment of the plurality of candidate segments that is extracted during both the first window of time and the second window of time, that user interest in the first candidate content segment is increasing, and generating a single stream of content segments, where the single stream of content segments includes a subset of the plurality of candidate content segments including the first candidate content segment.

The present disclosure relates generally to media distribution, and relates more particularly to devices, non-transitory computer-readable media, and methods for curating and compiling short-form segments of media in a manner that is based on temporal user behavior.

### BACKGROUND

Consumers (e.g., users of media content, hereinafter also referred to as simply “users”) are being presented with an ever increasing number of services via which media content can be accessed and enjoyed. For instance, streaming video and audio services, video on demand services, social media, and the like are offering more forms of content (e.g., short-form, always-on, raw sensor feed, etc.) and a greater number of distribution channels (e.g., mobile channels, social media channels, streaming channels, just-in-time on-demand channels, etc.) than have ever been available in the past. As the number of choices available to users increases and diversifies, service providers seeking to retain their customer bases are looking for ways to increase the engagement of their customers with their content.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for curating and compiling segments of media in a manner that is at least partially based on temporal user behavior may operate;

FIG. 2 illustrates a flowchart of an example method for curating and compiling segments of media in a manner that is based on temporal user behavior, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for curating and compiling segments of media in a manner that is based on temporal user behavior. In one example, a method performed by a processing system includes extracting a plurality of candidate content segments from a first item of media content, wherein the plurality of candidate content segments is extracted over a first window of time and a second window of time, determining, for a first candidate content segment of the plurality of candidate segments that is extracted during both the first window of time and the second window of time, that user interest in the first candidate content segment is increasing, and generating a single stream of content segments, where the single stream of content segments includes a subset of the plurality of candidate content segments including the first candidate content segment.

In another example, a non-transitory computer-readable medium may store instructions which, when executed by a processing system in a communications network, cause the processing system to perform operations. The operations may include extracting a plurality of candidate content segments from a first item of media content, wherein the plurality of candidate content segments is extracted over a first window of time and a second window of time, determining, for a first candidate content segment of the plurality of candidate segments that is extracted during both the first window of time and the second window of time, that user interest in the first candidate content segment is increasing, and generating a single stream of content segments, where the single stream of content segments includes a subset of the plurality of candidate content segments including the first candidate content segment.

In another example, a device may include a processing system including at least one processor and non-transitory computer-readable medium storing instructions which, when executed by the processing system when deployed in a communications network, cause the processing system to perform operations. The operations may include extracting a plurality of candidate content segments from a first item of media content, wherein the plurality of candidate content segments is extracted over a first window of time and a second window of time, determining, for a first candidate content segment of the plurality of candidate segments that is extracted during both the first window of time and the second window of time, that user interest in the first candidate content segment is increasing, and generating a single stream of content segments, where the single stream of content segments includes a subset of the plurality of candidate content segments including the first candidate content segment.

As discussed above, as the number of services via which users may access media content increases and diversifies, service providers seeking to retain their customer bases are looking for ways to increase the engagement of their customers with their content. One popular approach used by video distribution services has been to present viewers with sequences of curated video segments comprising the “highlights” of a program. Typically, these video segments are manually extracted by human operators (who typically determine which segments are most likely to be most interesting to viewers based on experience and/or domain knowledge), identified through analysis of video components and metadata (e.g., detecting facial expressions or crowd noise in the content which are assumed to be indicative of excitement), or identified through analysis of secondary data such as social media trends (e.g., segments being shared or discussed in social media). Although these approaches are generally successful in identifying the most popular content segments, these approaches are also costly in terms of resource usage and response latency.

Moreover, the curation process tends to be statically defined, e.g., by metadata, viewership timeframe, or explicit triggers for overall audience numbers. For instance, the curation process may seek the content segments with the greatest number of overall plays. However, user behavior and interests may change or shift over time. For instance, some content segments may remain consistently popular for a relatively long period of time. Other content segments, however, may see an initial surge in popularity immediately after being published, but user interest may drop off relatively quickly after that (e.g., due to depicting time-sensitive content, such as a preview for an upcoming episode of a television show). Still other content segments may not attract much user interest at first, but may see a late surge in popularity (e.g., due to sudden relevance to a trending news story). Thus, curation techniques that fail to account for the temporal nature of user behavior and interest may produce sequences of content segments whose content may be perceived as outdated, or alternatively, the sequences may fail to include content segments that experience a belated increase in interest.

Examples of the present disclosure may be used to prepare, in an automated manner, a personalized sequence of content segments (or a “highlight reel”) for a user or group of users, where the time relevance of the content segments is factored into the content segments' inclusion in the sequence. For instance, examples of the present disclosure may determine not just the overall popularity of a content segment (e.g., total number of plays), but the temporal nature of user interactions with the content segment at the point in time at which the sequence is to be prepared (e.g., did most of the plays occur in the first day of publication before dropping off, or is the content segment an “older” segment that is suddenly trending with users?).

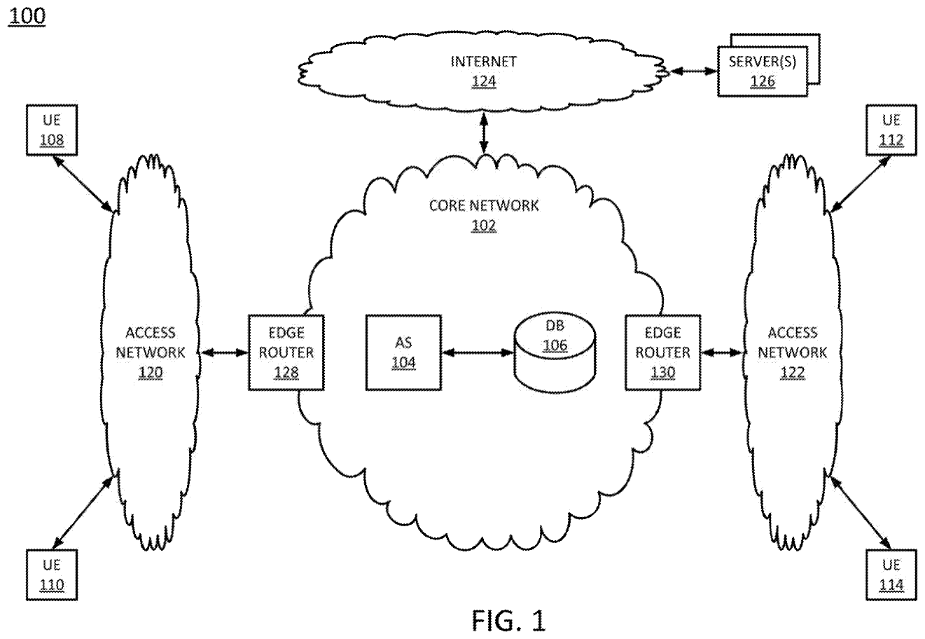

Further examples of the present disclosure may define groups of users based on the temporal aspects of the users' behaviors. For instance, examples of the present disclosure may be able to discern which users are more likely to set trends (e.g., more likely to play a content segment before the content segment gains a certain level of popularity) and which users are more likely to follow trends (e.g., more likely to play a content segment after the content segment has gained a certain level of popularity). Observing the behaviors of certain groups of users may help to identify content segments that may be of greater interest to other users, potentially even before the content segments see a large increase in user interest. These and other insights may be shared with the creators of the content segments, which may help the creators to create more engaging content segments in the future. These and other aspects of the present disclosure are discussed in greater detail below in connection with the examples of FIGS. 1-3.

To further aid in understanding the present disclosure, FIG. 1 illustrates an example system 100 in which examples of the present disclosure for curating and compiling segments of media in a manner that is based on temporal user behavior may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider. The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device. For example, the user endpoint devices 108, 110, 112, and 114 may each comprise a mobile device, a cellular smart phone, a gaming console, a set top box, a laptop computer, a tablet computer, a desktop computer, an application server, a bank or cluster of such devices, and the like.

In one example, one or more servers 126 may be accessible to user endpoint devices 108, 110, 112, and 114 via Internet 124 in general. The server(s) 126 may operate in a manner similar to the AS 104, which is described in further detail below.

In accordance with the present disclosure, the AS 104 and DB 106 may be configured to provide one or more operations or functions in connection with examples of the present disclosure for curating and compiling segments of media in a manner that is based on temporal user behavior, as described herein. For instance, the AS 104 may be configured to operate as a Web portal or interface via which a user endpoint device, such as any of the UEs 108, 110, 112, and/or 114, may access an application that provides media streams comprising pluralities of curated and compiled media segments.

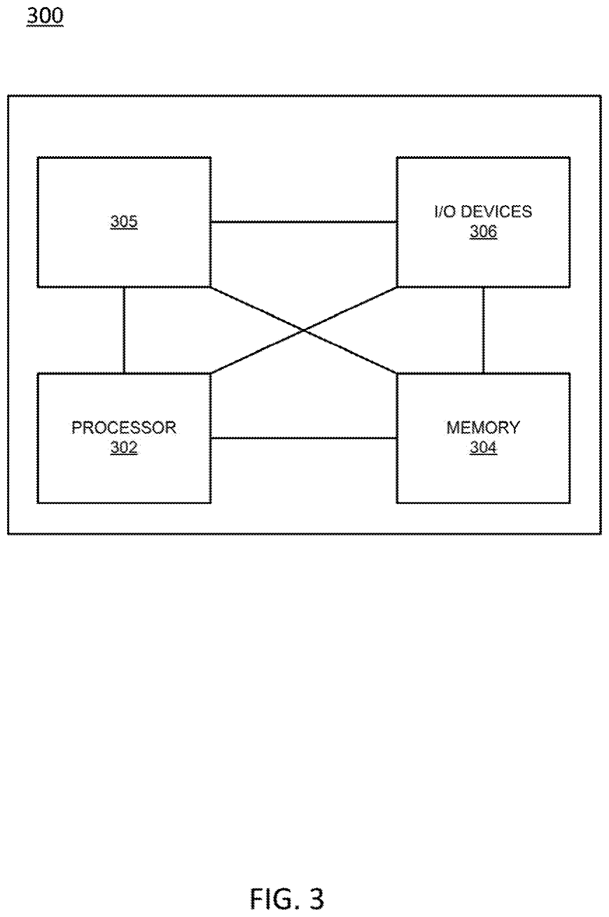

To this end, the AS 104 may comprise one or more physical devices, e.g., one or more computing systems or servers, such as computing system 300 depicted in FIG. 3, and may be configured as described above. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

For instance, in one example, the AS 104 may obtain a plurality of content segments that have been extracted from items of media content (e.g., television shows, movies, Internet videos, commercials podcasts, audiobooks, electronic books, radio programs, etc.). The AS 104 may identify, from among the plurality of content segments, which content segments may or may not be candidates for inclusion in a single stream of content segments that is to be compiled. In one example, selection of content segments for inclusion in the single stream may be based on the temporal behaviors of users of the items of media content. For instance, the AS 104 may first identify potentially interesting content segments (e.g., excerpts from items of media content, such as a specific scene of a television show or a specific interview from a radio program) based on consumption statistics for the content segments. In one example, the consumption statistics may indicate how many times the content segments were repeatedly consumed (e.g., watched, listened to, or read again after an initial watch, listen, or read, etc.) by individual users. Consumption of a content segment multiple times may indicate that something about the content segment is of particular interest to the users who consumed the content segment (and, thus, may potentially be of interest to other users who have not yet consumed the content segment). For instance, if multiple users rewatch the same commercial during a championship football game, this may indicate that the commercial was especially interesting to the users.

In one example, the AS 104 may go a step further and may analyze the consumption statistics of a content segment over multiple different windows of time (e.g., over at least a first window of time and a second window of time) in order to determine how a level of user interest in the content segment changes over time. For instance, if a scene of a television show generates a large volume of rewatches in the twenty-four hours immediately after the television show airs, but very few rewatches during the subsequent twenty-four hour period, then this may indicate that user interest in the scene was fleeting and has since leveled off. Conversely, if an exchange during a political debate does not get many rewatches during the airing of the debate, but gets a large volume of rewatches the day after the debate airs, then this may indicate that interest in the exchange is increasing late (potentially due to later viewers of the debate, such as viewers watching via DVR, rewatching the exchange). Understanding the temporal nature of user interest in a content segment may help the AS 104 to generate single streams of content that are more timely (e.g., to minimize inclusion of outdated content segments and/or to maximize the inclusion of content segments that are beginning to trend). Thus, the AS 104 may maximize user engagement with the single stream of content segments by including content segments in which users are likely to be currently interested, including content segments related to trending topics and interests.

The AS 104 may have access to at least one database (DB) 106, where the DB 106 may store content segments that have been identified (e.g., by the AS 104 or by another device) as potentially interesting (or, conversely, as potentially of little interest) based on consumption statistics. Each content segment may comprise a portion (e.g., an entirety or less than an entirety) of an item of media content. For instance, where the item of media content is a video (e.g., a film, a television show, an Internet video, or the like), the content segment may comprise a single scene from the video. Where the item of media content is a song, the content segment may comprise the chorus of the song, a guitar solo, or the like. Where the item of media content is a book, the content segment may comprise a paragraph, a scene, a chapter, or the like of the book. Where the item of media content is a podcast, the content segment may comprise an introduction of the podcast, an appearance by a guest, or the like.

Each content segment may be associated with a set of metadata that describes the content segment. For instance, the set of metadata associated with a content segment may indicate the type of the item of media content from which the content segment was extracted (e.g., video, audio, text, image, etc.), a genre of the content segment (e.g., romantic comedy, action, sports, etc.), an emotion or sentiment of the content segment (e.g., sad, happy, funny, etc.), a duration of the content segment (e.g., x number of seconds), and/or other information about the content segment or the item of media content. The metadata may be used by the AS 104, for instance, to filter candidate content segments that are available for compiling into a single stream of content segments. For instance, content segments for which the consumption statistics indicate a rising level of user interest may be better candidates for selection that content segments for which the consumption statistics indicate a falling level of user interest.

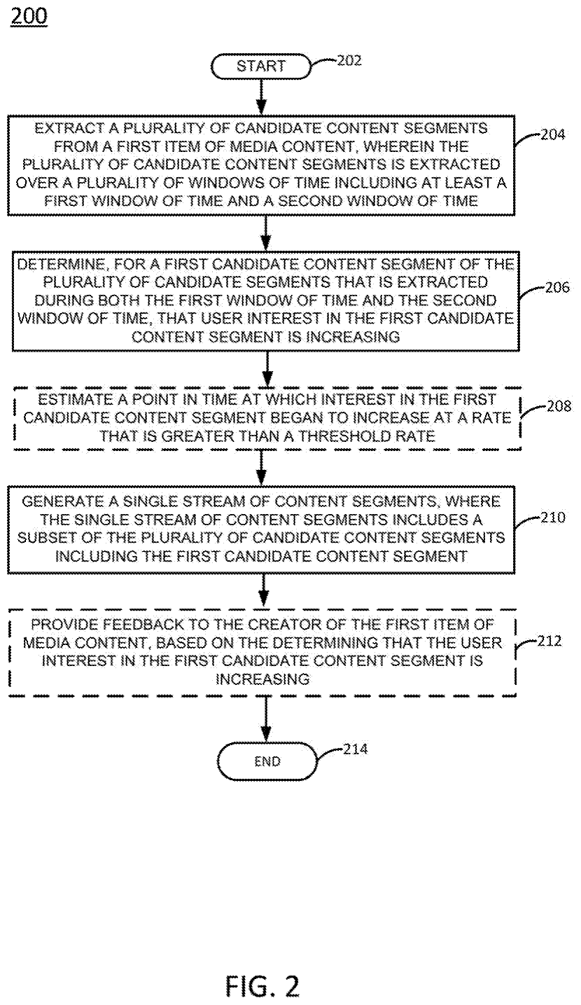

In one example, DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for curating and compiling segments of media in an automated, personalized manner, as described herein. An example method for curating and compiling segments of media in a manner that is based on temporal user behavior is described in greater detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 2 illustrates a flowchart of an automated example method 200 for curating and compiling segments of media in a manner that is based on temporal user behavior, in accordance with the present disclosure. In one example, steps, functions and/or operations of the method 200 may be performed by a device as illustrated in FIG. 1, e.g., AS 104 or any one or more components thereof. In one example, the steps, functions, or operations of method 200 may be performed by a computing device or system 300, and/or a processing system 302 as described in connection with FIG. 3 below. For instance, the computing device 300 may represent at least a portion of the AS 104 in accordance with the present disclosure. For illustrative purposes, the method 200 is described in greater detail below in connection with an example performed by a processing system, such as processing system 302.

The method 200 begins in step 202 and proceeds to step 204. In step 204, the processing system may extract a plurality of candidate content segments from a first item of media content, wherein the plurality of candidate content segments is extracted over a plurality of windows of time including at least a first window of time and a second window of time. In one example, first window of time and the second window of time are historical windows of time, e.g., windows of time (e.g., several hours, a day, a week, etc.) occurring subsequent to publication of the first item of media content. For instance, the first window of time may comprise a window of time from publication to twenty-four hours after publication, while a second window of time may comprise a window of time from publication to one week after publication.

In one example, the first window of time and the second window of time may have equal durations; however, in other examples, the first window of time and the second window of time may have unequal durations (e.g., the first window of time may be shorter or longer than the second window of time). In a further example, the first window of time and the second window of time may overlap each other (e.g., as in the example where the first window of time comprises the first twenty-four hours after publication and the second window of time comprises the first week after publication); however, in other examples, the first window of time and the second window of time may be non-overlapping (e.g., the first window of time may last from publication to twenty-four hours after publication, while the second window of time may last from twenty-four hours after publication to forty-eight hours after publication and so on). Moreover, the first window of time and the second window of time may be associated with the same set of users, or with different (or potentially overlapping) sets of users.

In one example, the first item of media content may be an audiovisual media (e.g., a movie, a television show, a video game, an online video, etc.), a visual-only media (e.g., a sequence or slideshow of still images), an audio-only media (e.g., a song, a podcast, a radio show, an audio book, etc.), a text-only media (e.g., an electronic book, a news article, a blog posting, etc.), or another type of media. Each candidate content segment of the plurality of candidate content segments may comprise an excerpt of the first item of media content (e.g., less than all of the first item of media content). For instance, a candidate content segment extracted from an episode of a television show may comprise a specific scene of the episode; a candidate content segment extracted from an episode of a radio show may comprise an interview with a celebrity; and the like.

In one example, the candidate content segments are extracted based on consumption statistics for the candidate content segment(s). As an example, candidate content segments extracted from an episode of a television show may comprise scenes of the episode that were the most rewatched by viewers of the episode. The scenes may therefore comprise the most salient or most potentially interesting portions of the episode (for the average viewer of the episode). Thus, the plurality of candidate content segments might comprise the x most rewatched scenes of a television episode during the first twenty-four hours after the initial airing of the episode (first window of time) and the y most rewatched scenes of the episode during the first week after the initial airing of the episode (second window of time). Alternatively, the processing system may extract all candidate content segments for which the number of rewatches at least meets a threshold number.

Similarly, consumption statistics could be used to extract the least potentially interesting content segments of the first item of media content. For instance, the scenes of the episode during which the greatest number of viewers tuned away from the episode (e.g., turned off the television, changed the channel, fast forwarded, etc.) may comprise the least salient or least potentially interesting portions of the episode (for the average viewer of the episode).

In one example, each candidate content segment may be associated with a defined set of boundaries, e.g., a start point (e.g., time stamp, frame number, or the like) and an end point (e.g., time stamp, frame number, or the like) in the first item of media content. As an example, referring to the example above of the scene from the episode of the television show, the defined set of boundaries may indicate that the scene begins in frame x of the episode and ends in frame x+y of the episode.

In another example, each candidate content segment may also be associated with a set of metadata describing the candidate content segment. The set of metadata may describe, for example, probabilistic tags across modalities (e.g., visual, audio, etc.). The set of metadata may indicate a genre of the candidate content segment (e.g., sports, comedy, news, etc.), an emotion or sentiment of the candidate content segment (e.g., happy, sad, scary, etc.), an identity of an individual appearing in the candidate content segment (e.g., actor, politician, public figure, etc.), and/or other information about the content of the candidate content segment. The set of metadata may also indicate other information about the candidate content segment that is not strictly content-related, such as the length of the candidate content segment, the image resolution of the candidate content segment, the file format of the candidate content segment, and/or other information. In a further example still, the metadata may indicate information about the candidate content segment that is obtained from an external data source and/or supplied by the creator of the first item of media content. For instance, if the candidate content segment comprises a scoring play from a football game, the metadata may indicate the score of the football game at the time of the candidate content segment or the final score of the football game. In another example, if the first item of media content included advertisements, the metadata may indicate the locations of scene cuts for cutting to commercials.

In a further example, the set of metadata may further indicate at least one of the following types of information: the network or channel on which the candidate content segment was distributed, the part of day (e.g., morning, afternoon, or night) during which the candidate content segment was first published, broadcast, or otherwise made available for public consumption, whether the candidate content segment is a new item or a repeated item (e.g., a recording or re-rerun of a previously broadcast candidate content segment), a season number associated with the candidate content segment, a number of advertisements occurring in the candidate content segment, the products or services advertised in the advertisements, the advertisers associated with the advertisements, metadata tags (e.g., video-, audio, and/or text-based metadata tags) indicating detected objects, recognized faces, voices, or names, scene descriptions, emotions or sentiments, silence, dialogue-derived variables, or the like, publicly available metrics associated with the candidate content segment (e.g., ratings, number of user shares, user and/or critic reviews), and/or other variables provided by the producer of the candidate content segment (e.g., filming or recording locations, scene boundaries, etc.).

In step 206, the processing system may determine, for a first candidate content segment of the plurality of candidate segments that is extracted during both the first window of time and the second window of time, that user interest in the first candidate content segment is increasing (or, alternatively, is decreasing). In one example, each candidate content segment may be associated with a set of consumption statistics, as described above. The set of consumption statistics may include, for example, the total or average number of times that users who consumed the first item of media content rewound, fast forwarded, and/or repeatedly consumed (e.g., rewatched, or listened to or read again after an initial watch, listen, or read) the first candidate content segment, which indicates a level of user interest in the first candidate content segment.

The consumption statistics for the first candidate content segment may be compared from the first time window to the second time window, e.g., to see whether interest in the first candidate content segment is increasing, decreasing, or staying relatively consistent over time. For instance, if the first candidate content segment was rewatched one hundred times during the first window of time, but was rewatched five thousand times during the second window of time, then this may indicate that interest in the first candidate content segment is increasing over time (or that the first candidate content segment has longevity).

Similarly, the processing system may determine that user interest is decreasing for another candidate content segment, such as a second candidate content segment of the plurality of candidate content segments. For instance, if the second candidate content segment was rewatched five thousand times during the first window of time, but was rewatched one hundred times during the second window of time, then this may indicate that user interest in the second candidate content segment is decreasing over time (or that the second candidate content segment does not have longevity).

In optional step 208 (illustrated in phantom), the processing system may estimate a point in time at which interest in the first candidate content segment began to increase at a rate that is greater than a threshold rate (e.g., a first threshold rate). In one example, the rate of increase in interest may be defined in terms of the consumption statistics described above (e.g., as a number of rewatches of the first candidate content segment over a defined period of time). Thus, the processing system may be able to estimate when interest in the first candidate content segment began to move significantly in a different direction.

It should be noted that significant movement in a different direction may be detected in the opposite sense as well. For instance, for a candidate content segment for which user interest is decreasing, such as the second candidate content segment described above, the processing system may be able to estimate a point in time at which interest in the second candidate content segment began to fall at a rate that is greater than a threshold rate (e.g., a second threshold rate).

In one example, the estimated point in time at which interest in the first candidate content segment began to increase at a rate that is greater than a first threshold rate (or, conversely, began to decrease at a rate that is greater than a second threshold rate) may be associated with a confidence. In one example, the confidence may be proportional to a number of users on whose behaviors the consumption statistics were based. For instance, a number of rewatches for the first candidate content segment may be observed to increase at a rate that is greater than the first threshold rate. However, if the actual number of users who rewatched over the window of time at which the increase is observed is relatively small (e.g., one hundred users), then the confidence in the estimate may be relatively low. However, if the actual number of users who rewatched over the window of time at which the increase is observed is relatively large (e.g., seventy percent of users in a given city), then the confidence in the estimate may be higher.

In step 210, the processing system may generate a single stream of content segments, where the single stream of content segments includes a subset of the plurality of candidate content segments including the first candidate content segment. In one example, the first candidate content segment may be selected for inclusion in the single stream of content based on the increasing user interest in the first candidate content segment. In one example, the single stream of content segments may present the subset of the plurality of candidate content segments one at a time, in a continuous, concatenated manner (e.g., such that a user consuming the single stream of content segments does not need to initiate presentation of each individual content segment in the single stream). For instance, the single stream of content segments may comprise a continuous sequence of video clips, audio clips, images, and/or the like.

In one example, breaks or advertisements may be inserted between the individual content segments in the single stream of content segments. For instance an advertisement may be inserted between two content segments in which user interest is observed to be currently increasing, thereby increasing the probability of a user paying attention to the advertisement. The single stream of content segments may be stored in a location where it can be accessed when a user is ready to consume the single stream of content segments.

In optional step 212 (illustrated in phantom), the processing system may provide feedback to the creator of the first item of media content, based on the determining that the user interest in the first candidate content segment is increasing. The feedback may not necessarily comprise the fact that the user interest in the first candidate content segment is increasing, but may instead comprise an insight that is related to the increase in user interest.

For instance, in one example, the processing system may correlate the increase in user interest in the first candidate content segment with data from an external data source, which may provide insights into factors that influence user behavior with respect to content segments. As an example, the external data source may be a social media site, where a posting on the social media site may reference the first candidate content segment in some way (e.g., posting video of the first candidate content segment, asking a question about the first candidate content segment, etc.). The correlation of the increase in interest to the data from the external data source may be based on both the content of the data from the external data source (e.g., indicating some relation to the first item of media content and/or the first candidate content segment) and the timing of the data from the external data source. For instance, referring again to the social media posting example, a social media posting that was made one week before there was any noticeable increase in user interest might be assumed to have had little effect on the increase in user interest; however, a social media posting that was made a few hours before a noticeable increase in user interest was observed might be assumed to have triggered at least part of the increase in user interest.

In another example, the external data source may be user search histories from Internet search engines, where the user search histories reference the first candidate content segment. For instance, the search histories may show an increase in searches for an item that appeared in the first candidate content segment or an event that occurred in the first candidate content segment (e.g., a product that was depicted in a video clip or a line of dialogue that may have been difficult to understand). As above, the correlation between the search histories and the first candidate content segment may be based in part on some temporal relations (e.g., the closer in time the correlation is observed, the more likely the search histories are to be related to the first candidate content segment). Knowing when the Internet search histories are strongly correlated with an increase in interest in the first candidate content segment may, for example, help content creators to improve product placement opportunities to maximize user interest in placed products.

Thus, identifying correlations may help to identify sources of causes of changes in user interest levels. For instance, news articles, celebrity endorsements or social media postings, and the like may be identified as triggers that may cause interest in certain content segments to increase or decrease at specific times. This information may help content creators to identify ways to encourage better user engagement and create more interest in their content.

Moreover, knowing which content segments generate more user interest early versus late in life may help content creators to adjust the manner in which content may be created, potentially implementing a dynamic system for presenting content (e.g., presenting different content segments in different orders to maximize user interest). For instance, the content segments that are most interesting to users who consume content earlier (e.g., closer to publication) may be different than the content segments that are most interesting to users who consume content later (e.g., less close to publication).

The method 200 may end in step 214.

Thus, examples of the present disclosure recognize that user interest in content segments (e.g., excerpts of content) increase or decrease over time, potentially in a manner that is unrelated to the age of the content. For instance, a car chase scene in a television show may immediately generate a high level of viewer interest, whereas a nuanced question or dialogue in a political debate might emerge as a highlight of the program only after the debate is complete. Recognition of these temporal user behaviors may help to create a single stream of content segments that is considered more timely and/or more interesting by users. For instance, a first content segment that generated a large amount of total user interest over its lifetime, but in which current user interest seems to dropping, may be less likely to be selected for inclusion in the single stream of content. Conversely, a second content segment that did not generate as much total user interest, but in which current user interest seems to be suddenly increasing, may be more likely to be selected for inclusion in the single content stream.

Recognition of these temporal user behaviors may also allow for summaries or trend analyses to be generated according to content type. For instance, if car chase scenes are detected to be increasing in popularity across many different instances of content (e.g., episodes of different television shows), this may indicate an emerging concept trend. As another example, during the time period between Halloween and Christmas, segments of content depicting ghosts and pumpkins may suddenly decrease in popularity, while segments of content depicting Santa Claus and reindeer may increase in popularity.

Insights generated using the method 200 may be used to curate different types of streams of content for different user interests. For instance, one stream could be curated that comprises a plurality of content segments in which total user interest over the lifetimes of the content segments was high (e.g., “classics”). Another stream could be curated that comprises a plurality of content segments in which user interest increased later in the lifetimes of the content segments (e.g., “you may have missed this”). Another stream could be curated that comprises a plurality of content segments in which there is little user interest, e.g., content deemed to be boring or content deemed to be scary (e.g., “you may be scared by this,” “you may want to omit this type of content in your next media content creation effort”, and so on). These different types of content streams could be provided as a service to help users find information about interesting topics, join conversations, link to social media applications, and the like.

A further advantage of the present disclosure may be the ability to learn from user temporal behavior over multiple items of content (e.g., within a series or enterprise) to generate more global insights for interesting moments. This may help content providers to adjust the presentation of content to better align with user interests and temporal behavior. For instance, by better understanding how user interests change over time, content creators may adjust the timing and frequency with which certain types of content are presented. As an example, a content creator may determine that car chase scenes are a good way to generate user interest, as well as how often to incorporate such scenes in a television series to maximize user interest. Alternatively, a content creator may evaluate the relative values of scenes involving a single superhero in one television episode versus multiple superheroes across multiple television episodes. Associations between specific types of content (e.g., romantic scenes, funny monologues, etc.) and specific temporal qualities (e.g., consistent interest level versus immediately high interest level that drops off) may also be learned and used to inform the content creator process.

As also noted above, examples of the present disclosure may be useful in identifying users who are considered trend setters or followers when it comes to consuming segments of content that are increasing in popularity. For instance, certain users may tend to be “early” viewers of segments that later become more widely popular among the population of users, while other users may be more likely to view segments only after the segments have reached a certain degree of popularity. In some examples, the processing system may aggregate and average multiple user behaviors as a trend leader or follower to discover these types of users (as opposed to discovering the content these types of users look at). Later, when similar behaviors are observed in a user who has been identified as a trend setter, the processing system may be better able to predict whether a new segment viewed by the user is likely to see an increase in popularity.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for curating and compiling segments of media in a manner that is based on temporal user behavior, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for curating and compiling segments of media in a manner that is based on temporal user behavior (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for curating and compiling segments of media in a manner that is based on temporal user behavior (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

1. A method comprising:
extracting, by a processing system including at least one processor, a plurality of candidate content segments from a first item of media content, wherein the plurality of candidate content segments is extracted over a first window of time and a second window of time, wherein the extracting comprises:
identifying, by the processing system, a first number of content segments of the first item of media content for which a consumption statistic is greatest during the first window of time, wherein the consumption statistic quantifies a number of times that a corresponding content segment of the first item of media content was repeatedly consumed by users after initial consumptions by the users; and
identifying, by the processing system, a second number of content segments of the first item of media content for which the consumption statistic is greatest during the second window of time;
determining, by the processing system for a first candidate content segment of the plurality of candidate segments that is extracted during both the first window of time and the second window of time, that user interest in the first candidate content segment is increasing; and
generating, by the processing system, a single stream of content segments, where the single stream of content segments includes a subset of the plurality of candidate content segments including the first candidate content segment.

2. The method of claim 1, wherein the first window of time and the second window of time are both historical windows of time occurring subsequent to a publication of the first item of media content.

3. The method of claim 1, wherein the first window of time and the second window of time overlap.

4. The method of claim 1, wherein the first window of time and the second window of time are non-overlapping windows of time.

5. The method of claim 1, wherein a duration of the first window of time is equal to a duration of the second window of time.

6. The method of claim 1, wherein a duration of the first window of time is greater than a duration of the second window of time.

7. (canceled)

8. The method of claim 1, wherein the determining comprises:
identifying, by the processing system, the first candidate content segment that occurs in both the first number of content segments and the second number of content segments; and
determining, by the processing system for the first candidate content segment, that the consumption statistic during the second window of time is greater than the consumption statistic during the first window of time.

9. The method of claim 8, further comprising:
estimating, by the processing system based on the consumption statistic during the first window of time for the first candidate content segment and the consumption statistic during the second window of time for the first candidate content segment, a point in time at which the user interest in the first candidate content segment begins to change at a rate that is greater than a threshold rate.

10. The method of claim 9, wherein the rate is defined as a number of repeated consumptions after initial consumptions of the first candidate content segment over a defined period of time.

11. The method of claim 10, wherein the estimating is associated with a confidence that is proportional to a number of users on whose behaviors the consumption statistic during the first window of time for the first candidate content segment and the consumption statistic during the second window of time for the first candidate content segment are based.

12. The method of claim 1, further comprising:
providing, by the processing system, feedback to a creator of the first item of media content, based on the determining that the user interest in the first candidate content segment is increasing.

13. The method of claim 12, wherein the feedback comprises a correlation of an increase in the user interest with data from an external data source.

14. The method of claim 13, wherein the data from the external data source comprises a posting on a social media site that references the first candidate content segment.

15. The method of claim 13, wherein the data from the external data source comprises user search histories from internet search engines, wherein the user search histories reference the first candidate content segment.

16. The method of claim 15, wherein the user search histories include an increased number of searches for at least one of: an item appearing in the first candidate content segment or an event occurring in the first candidate content segment.

17. The method of claim 1, wherein the single stream of content segments includes a plurality of content segments in which user interest increased later in lifetimes of the plurality of content segments.

18. The method of claim 1, further comprising:
determining, by the processing system for a second candidate content segment of the plurality of candidate content segments that is extracted during both the first window of time and the second window of time, that user interest in the second candidate content segment is decreasing; and
excluding, by the processing system, the second candidate content segment from the single stream of content segments.

19. A non-transitory computer-readable medium storing instructions which, when executed by a processing system including at least one processor, cause the processing system to perform operations, the operations comprising:
extracting a plurality of candidate content segments from a first item of media content, wherein the plurality of candidate content segments is extracted over a first window of time and a second window of time, wherein the extracting comprises:
identifying a first number of content segments of the first item of media content for which a consumption statistic is greatest during the first window of time, wherein the consumption statistic quantifies a number of times that a corresponding content segment of the first item of media content was repeatedly consumed by users after initial consumptions by the users; and
identifying a second number of content segments of the first item of media content for which the consumption statistic is greatest during the second window of time;
determining, for a first candidate content segment of the plurality of candidate segments that is extracted during both the first window of time and the second window of time, that user interest in the first candidate content segment is increasing; and
generating a single stream of content segments, where the single stream of content segments includes a subset of the plurality of candidate content segments including the first candidate content segment.

20. A device comprising:
a processing system including at least one processor; and
a non-transitory computer-readable medium storing instructions which, when executed by the processing system, cause the processing system to perform operations, the operations comprising:
extracting a plurality of candidate content segments from a first item of media content, wherein the plurality of candidate content segments is extracted over a first window of time and a second window of time, wherein the extracting comprises:
identifying a first number of content segments of the first item of media content for which a consumption statistic is greatest during the first window of time, wherein the consumption statistic quantifies a number of times that a corresponding content segment of the first item of media content was repeatedly consumed by users after initial consumptions by the users; and
identifying a second number of content segments of the first item of media content for which the consumption statistic is greatest during the second window of time;
determining, for a first candidate content segment of the plurality of candidate segments that is extracted during both the first window of time and the second window of time, that user interest in the first candidate content segment is increasing; and
generating a single stream of content segments, where the single stream of content segments includes a subset of the plurality of candidate content segments including the first candidate content segment.

21. The method of claim 1, further comprising extracting another plurality of candidate content segments from the first item of media content, wherein the another plurality of candidate content segments comprises a set of content segments that is inferred to be least interesting to the users, wherein inclusion of a potential content segment in the set of content segments is based on at least one of: a number of the users who turned off a device on which the first item of media content was being presented during presentation of the potential content segment, a number of the users who tuned a device away from the first item of media content during presentation of the potential content segment, or a number of the users who fast forwarded through the first item of media content during presentation of the potential content segment.
